(19) United States
(12) Patent Application Publication
(10) Pub. No.: US 2012/0102137 A1
(43) Pub. Date: Apr. 26, 2012

(54) CLUSTER CACHE COHERENCY PROTOCOL

(76) Inventors: Arvind PRUTHI, Los Gatos, CA (US); Ram Kishore JOHRI, San Jose, CA (US); Abhijeet P. GOLE, Cupertino, CA (US)

(21) Appl. No.: 13/278,453

(22) Filed: Oct. 21, 2011

Related U.S. Application Data
(60) Provisional application No. 61/406,428, filed on Oct. 25, 2010.

(51) Int. Cl. G06F 15/167

(52) U.S. Cl. 709/213

(57) ABSTRACT

Systems, methods, and other embodiments associated with a cluster cache coherency protocol are described. According to one embodiment, an apparatus includes non-transitory storage media configured as a cache associated with a computing machine. The computing machine is a member of a cluster of computing machines that share access to a storage device. A cluster caching logic is associated with the computing machine. The cluster caching logic is configured to communicate with cluster caching logics associated with the other computing machines to determine an operational status of a clique of cluster caching logics performing caching operations on data in the storage device. The cluster caching logic is also configured to selectively enable caching of data from the storage device in the cache based, at least in part, on a membership status of the cluster caching logic in the clique.

### CROSS REFERENCE TO RELATED APPLICATIONS

This present disclosure claims the benefit of U.S. provisional application Ser. No. 61/406,428 filed on Oct. 25, 2010, which is hereby wholly incorporated by reference.

### BACKGROUND

The background description provided herein is for the purpose of generally presenting the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

Storage Area Networks (SANS) provide a large amount of storage capacity that can be shared by a cluster of several computing machines or servers. The machines typically communicate with a SAN using the SCSI protocol by way of the internet (iSCSI) or a fibre channel connection. Often, the machine will include a SCSI interface card or controller that controls the flow of data between the machine and the SAN. To the machine, the SAN will appear as though it is locally connected to the operating system. Because all of the machines in the cluster have access to the shared memory in the SAN, caching on the individual machines is often disabled to avoid difficulties in maintaining coherency among the caches on the various machines.

### SUMMARY

In one embodiment an apparatus includes non-transitory storage media configured as a cache associated with a computing machine. The computing machine is a member of a cluster of computing machines that share access to a storage device. A cluster caching logic is associated with the computing machine. The cluster caching logic is configured to communicate with cluster caching logics associated with the other computing machines to determine an operational status of a clique of cluster caching logics performing caching operations on data in the storage device. The cluster caching logic is also configured to selectively enable caching of data from the storage device in the cache based, at least in part, on a membership status of the cluster caching logic in the clique.

In one embodiment, the cluster caching logic is configured to enable caching of data from the storage device when the cluster caching logic is a member of the clique and to disable caching when the cluster caching logic is not a member of the clique. In one embodiment, the cluster caching logic is configured to disable caching of data from the storage device when a health status of the clique is degraded. In one embodiment, the cluster caching logic is configured to invalidate data in the cache of the computing machine when the computing machine ceases hosting of a virtual machine having a virtual disk file cached in the cache.

In another embodiment, a method includes determining membership in a clique of caching logics that cache data from a shared storage device; and if membership in the clique is established, enabling caching of data from the shared storage device in a cache.

In one embodiment, the method also includes broadcasting a health check message to other clique members; monitoring for a response from the other clique members; and if a response is not received from the other clique members, broadcasting a clique degradation message indicating that a health status of the clique is degraded. In one embodiment, the method includes invalidating data in the cache corresponding to a virtual disk of a virtual machine if the virtual machine is deleted. In one embodiment, the method includes invalidating data in the cache corresponding to a virtual disk of a virtual machine if the virtual machine moves to a different host computing machine. In one embodiment, the method includes disabling caching in response to receiving a clique degradation message received from a member of the clique.

In one embodiment, the method includes detecting a persistent reserve message from a requesting cluster caching logic in the clique reserving exclusive access to the shared memory device; recording a list of memory blocks written by the requesting cluster caching logic while the shared storage device is reserved; detecting a revocation message from the requesting cluster caching logic; broadcasting the list of memory blocks to the cluster caching logics in the clique; and broadcasting a clique degradation message indicating that a health status of the clique is degraded if a response is not received from all members of the clique.

In another embodiment, a device includes a cluster cache controller configured for coupling to a physical computing machine. The cluster cache controller is configured to assess a health status of a clique of cluster cache controllers that cache data from a shared storage device; determine the cluster cache controller's membership status with respect to the clique; and if the cluster cache controller is a member of the clique and the health status of the clique is not degraded, enabling caching in a cache associated with the physical computing machine.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates one embodiment of a system associated with a cluster cache coherency protocol for clustered volumes.

FIG. 2 illustrates one embodiment of a method associated with a cluster cache coherency protocol.

FIG. 3 illustrates one embodiment of a method associated with a cluster cache coherency protocol.

FIG. 4 illustrates one embodiment of a method associated with a cluster cache coherency protocol.

FIG. 5 illustrates one embodiment of a method associated with a cluster cache coherency protocol.

FIG. 6 illustrates one embodiment of a system associated with a cluster cache coherency protocol.

### DETAILED DESCRIPTION

As CPU capabilities increase, the use of virtual machines has become widespread. Operating systems like Vmware and Windows Hyper-V allow a single physical machine to run multiple instances of an operating system that each behave as a completely independent machine. A virtual machine's operating system instance accesses a virtual “disk” in the form of a file that is often stored in a SAN. Storing a virtual machine's virtual disk file on the SAN allows a virtual machine to be moved seamlessly between physical machines. As long as the SAN is accessible by two or more physical machines in a virtualization cluster, the virtual machine can be moved between the machines.

Accessing the SAN typically involves a high latency, thereby resulting in a need to cache a virtual machines virtual disk file. However, cache coherence should be addressed with a virtualization cluster of multiple physical machines accessing the same SAN. If a virtual machine moves from one physical machine (A) to another (B), the cache on the machine A for the virtual machine needs to be invalidated before B can start caching data from the moved virtual machine. The storage used by the virtual machine may be in the form of a file on top of a block device (SAN), eg., vmdk files on vmfs. (In such cases, the block device is typically formatted with a cluster-aware file system such as vmfs). The physical machine's cache which typically operates on top of the block layer may not be able to identify which blocks are associated with any given virtual machine's file and would thus not be able to identify which blocks should be invalidated.

Described herein are example systems, methods, and other embodiments associated with a cluster cache coherency protocol. Using the cluster coherency protocol, a cluster of computing machines that share access to a storage device can perform local caching while dynamically resolving cache coherency issues. The coherency protocol allows the individual computing machines in the cluster to collaborate to facilitate cache coherency amongst the computing machines. In some embodiments, the cluster of computing machines is a virtualization cluster of computing machines that host a plurality of virtual machines.

Using the clustered cache coherency protocol, the right for a computing machine in a cluster to perform caching operations depends on membership in a clique of machines that are caching from the same shared storage device. The computing machines in the clique communicate with one another to determine that the clique is “healthy” (e.g., communication between the members is possible). Members of the clique adhere to the protocol and perform caching-related operations according to the protocol. As long as the clique is healthy, and the clique members obey the protocol, cache coherency amongst the members of the clique can be maintained.

Because virtual machines tend to access a dedicated block of storage that functions as the virtual disk for the virtual machine, virtual machines do not typically access blocks of storage that have been allocated to other virtual machines. This makes the cluster cache coherency protocol described herein well suited for use in a virtual machine environment because it facilitates caching of a virtual machine's virtual disk file on the host machine while allowing the virtual machine to be moved seamlessly to another host machine.

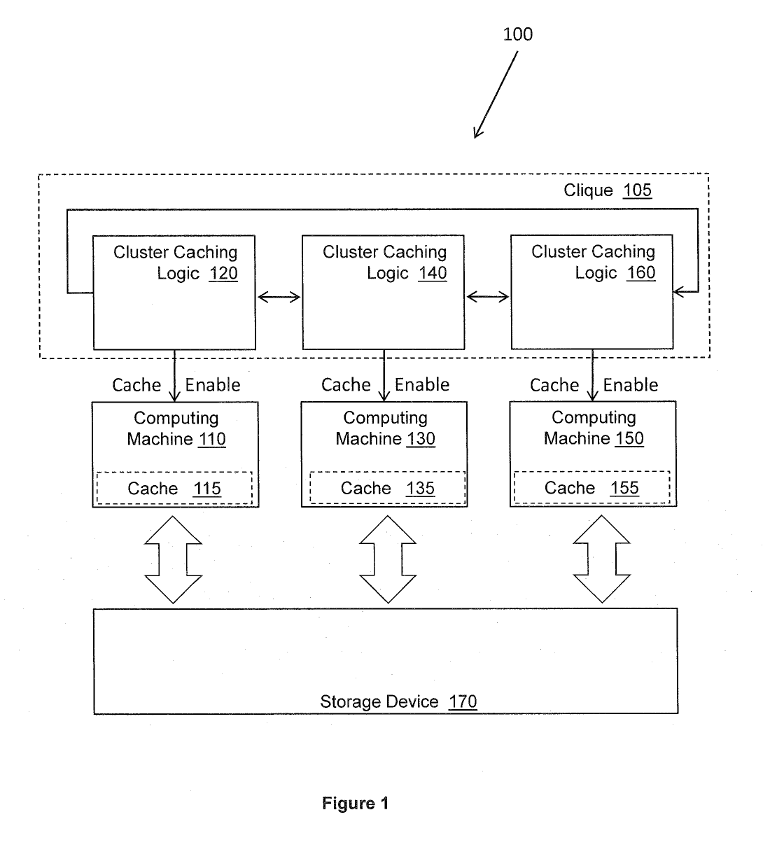

With reference to FIG. 1, one embodiment of a system 100 is shown that is associated with a cluster cache coherency protocol. The system 100 includes three computing machines 110, 130, 150 that share access to a storage device 170. The computing machines 110, 130, 150 include at least a processor (not shown) and local memory that is configured for use as a cache 115, 135, 155. While only three computing machines are shown in FIG. 1, the cluster cache coherency protocol described herein can be used with any number of computing machines. To facilitate cache coherency amongst the machines, a cluster cache coherency protocol is established between cluster caching logics 120, 140, 160 that control the local caching for the computing machines 110, 130, 150, respectively.

In one embodiment, the cluster cache coherency protocol is an out-of-band (outside the data path) protocol that provides semantics to establish cache coherency across multiple computing machines in a virtualization cluster that access a shared block storage device (e.g., SAN). In some embodiments, the cluster caching logics 120, 140, 160 are embodied on an SCSI interface card installed in a computing machine. The cluster caching logic may be embodied as part of an “initiator” in a Microsoft operating system. The cluster caching logics may be embodied in any logical unit that is capable of communicating with other caching logics and enabling/disabling caching on a physical computing machine of data from a shared storage device.

For the purposes of the following description, the operation of only one computing machine 110, the associated cache 115, and cluster caching logic 120 will be described. The computing machines 130, 150, the associated caches 135, 155 and cluster caching logics 140, 160 operate in a corresponding manner. According to one embodiment of the cluster cache coherency protocol, the cluster caching logic 120 enables caching in the cache 115 when it is a member of a clique 105 and when the clique is healthy. A cluster caching logic is a member of the clique when it is able to communicate with all other members of the clique. Thus, the cluster caching logic 120 can be a member of the clique and enable caching operations for the computing machine 110 when the cluster caching logic 120 can communicate with the other members of the clique 105 (i.e., cluster caching logics 140, 160).

In one embodiment, it is assumed that during normal operation, each physical computing machine in the cluster accesses memory blocks from the shared storage device 170. This is a safe assumption for a virtualization cluster in which the virtual machines typically do not share memory blocks, but rather each access a set of memory blocks reserved for use as a virtual disk file. For cache coherency to be maintained, the clique 105 includes a cluster caching logic 120, 140, 160 for all physical computing machines 110, 130, 150 that are accessing (and may cache) data from the shared storage device 170. According to the protocol, if a cluster caching logic cannot communicate with the other cluster caching logics, it must disable caching operations for data from the shared storage device 170 and invalidate any data in the associated cache that is from the shared storage device. A failure in communication may occur due to a breakdown of a network connection used by the cluster caching logics to communicate with one another.

A cluster caching logic (120, 140, 160) can register or de-register from the clique at any time. The cluster caching logic (120, 140, 160) can only do caching for the shared storage device 170 if it is currently part of the clique 105. When a cluster caching logic de-registers from the clique, it is assumed that it is no longer performing caching operations for the shared storage device 170. If a cluster caching logic registers with the clique 105, then it is treated on par with the other members of the clique. The newly registered cluster caching logic will start receiving and handle messages for the clique 105.

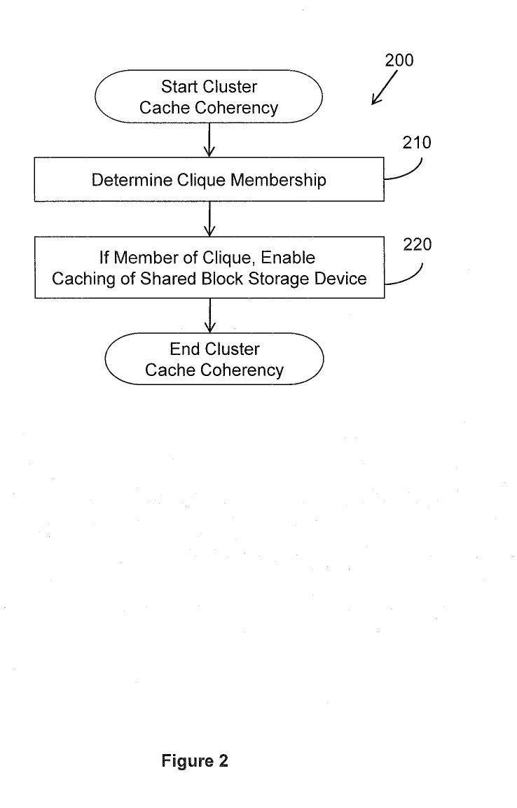

FIG. 2 illustrates one embodiment of a cluster cache coherency method 200 that is performed in practice of the cluster cache coherency protocol. In some embodiments, the method 200 is performed by the cluster caching logics 120, 140, 160. At 210, membership in a clique of cache controllers (e.g., cluster caching logics) is determined. At 220, if membership in the clique is established, caching of data from the shared storage device is enabled.

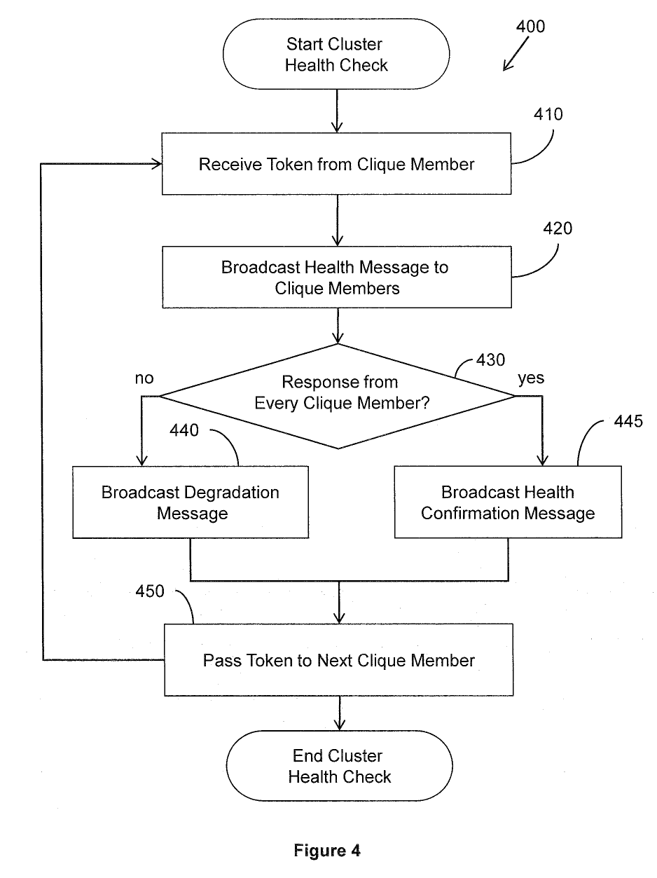

When a cluster caching logic boots up, it reads a list of peer cluster caching logics that are part of the clique performing cluster coherent caching on a shared storage device. The cluster caching logic tries to register itself to the clique by going through the list. If any other cluster caching logic replies to a message from the cluster caching logic, the cluster caching logic is a member of the clique. From this point onwards, the cluster caching logic is allowed to enable caching of data for the shared storage device. The cluster caching logic is also expected to participate in the clique, including performing health checks and token passing as will be described below in connection with FIG. 4.

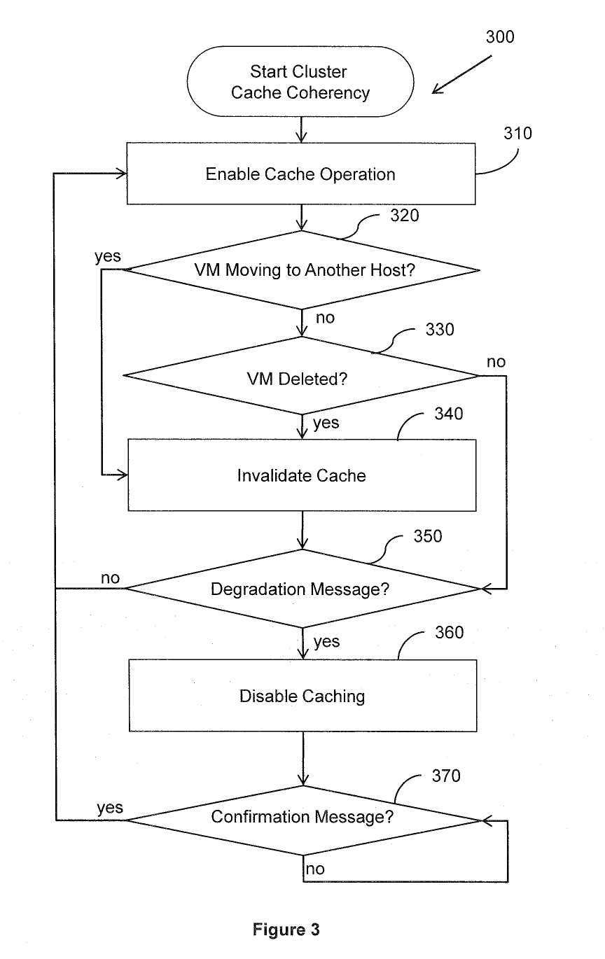

FIG. 3 illustrates one embodiment of a cluster cache coherency method 300 that is performed in practice of the cluster cache coherency protocol. In some embodiments, the method 300 is performed by the cluster caching logic 120, 140, 160 (FIG. 1) in a virtualization cluster hosting multiple virtual machines. At 310, caching is enabled due to membership in the clique. At 320, a determination is made as to the whether a virtual machine hosted by an associated physical computing machine is moving to another host. At 330, a determination is made as to the whether a virtual machine hosted by an associated physical computing machine is being deleted. If a virtual machine is being deleted, at 340, data in the cache from the shared storage device is invalidated. Invalidation of the data in the cache does not require a cluster caching logic to disable caching operations, rather the cluster caching logic may continue to cache so long as it remains a member of the clique.

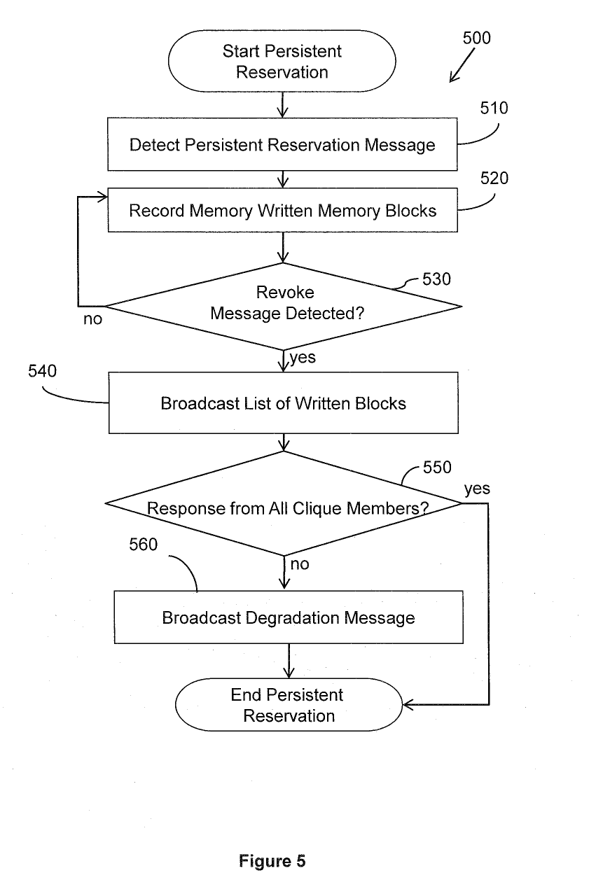

At 350, a determination is made as to whether a degradation message has been received. If a degradation message has been received, at 360, caching is disabled. Degradation messages may be broadcast by a clique member as a result of a failed health check or during processing of a PERSISTANT RESERVATION request, as will be described in connection with FIGS. 4 and 5, respectively. Caching is disabled until, at 370, a health confirmation message is received, at which point, caching may be enabled.

FIG. 4 illustrates one embodiment of a cluster cache coherency method 400 that is performed in practice of the cluster cache coherency protocol. In some embodiments, the method 400 is performed by the cluster caching logic 120, 140, 160. At 410, a token is received from a clique member. In response to receiving the token, at 420, a health check message is broadcast to all members of the clique. At 430, a determination is made as to the whether all clique members have responded to the health check message. If all of the other clique members did not respond, at 440 a degradation message is sent to all clique members. If the other clique members did respond, at 445 a health confirmation message is sent to all clique members. At 450, the token is passed to a next clique member to perform the next health check on the clique.

FIG. 5 illustrates one embodiment of a persistent reservation method 500 that is performed in practice of the cluster cache coherency protocol. In some embodiments, the method 500 is performed by a cluster caching logic that is serving as a metadata master of a virtualization cluster. The metadata master formats the shared storage device with a cluster file system. The metadata master is responsible for metadata modification to the cluster file system. In some circumstances, a cluster caching logic in the cluster may issue a SCSI PERSISTENT RESERVATION request to the shared storage device. This request is typically performed to allow updating of metadata that is necessary when virtual machines are created or moved between physical machines. Following the request, the cluster caching logic typically will perform write I/O requests to update the metadata to reflect the presence of the virtual machine on a new physical machine. During these write operations, no other cluster caching logics may access the storage device.

Once the metadata has been updated, the reserving cluster caching logic issues a revocation of the PERSISTENT RESERVATION and caching operations may resume for the cluster caching logics not related to the prior host of the virtual machine. As already discussed above in connection with FIG. 3, per the cluster cache coherency protocol, a cluster caching logic invalidates data in the cache for any virtual machine that moves or is deleted from the physical machine associated with the cluster caching logic.

Returning to the method 500, at 510, a PERSISTENT RESERVATION message is detected by a cluster caching logic associated with the metadata master. The message may have been issued by any cluster caching logic in the cluster, but the cluster caching logic associated with the metadata master performs the method 500. At 520, a list of memory blocks written to during the reservation is recorded until a revoke message is detected at 530. At 540, the list of blocks that were written to during the reservation is sent in a broadcast message to all members of the clique. The message will prompt all members of the clique to invalidate their caches for the metadata blocks overwritten during the reservation. At 550, a determination is made as to whether a response has been received by all members of the clique. If a response has been received, the method ends. If a response was not received from all members of the clique, at 560 a degradation message is broadcast to the members of the clique.

In one embodiment, the cluster cache coherency protocol allows cluster caching logics and/or cluster cache controllers to join a clique, exit a clique, perform clique health checks, update clique status, invalidate a range of memory blocks in a cache, invalidate a shared cache, stop caching, start caching, and pass tokens. The cluster cache coherency protocol enables peer-to-peer communications to maintain cache coherency in a virtualization cluster without the need to modify operation of a shared storage device in any way.

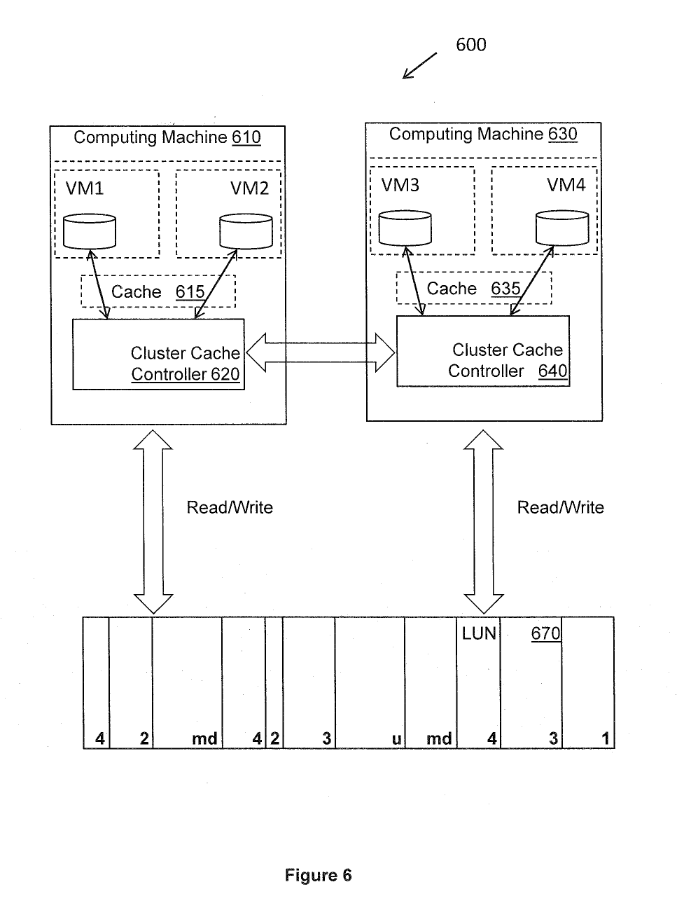

FIG. 6 illustrates one embodiment of a clustered virtualization environment 600 associated with a cluster cache coherency protocol. In the virtualization environment 600, there are two physical computing machines 610, 630. The physical computing machine 610 acts as a host machine for virtual machines VM1 and VM2, while the machine 630 acts as host for virtual machines VM3 and VM4. A shared LUN 670 is exported to both machines 610, 630. The computing machine 610 acts as metadata master in this virtualization environment. The metadata master formats the LUN 670 with a cluster file system. The metadata master is responsible for metadata modification to the cluster file system.

Each virtual machine creates its own virtual disk as a file on the LUN 670. The virtual disk files for each machine are labeled with a corresponding number in the LUN 670 (“md” indicates metadata while “u” indicates unallocated blocks). After the metadata master has created the virtual disk files, the individual virtual machines retain complete ownership of these files. However, any changes related to the metadata of the cluster file system (e.g., addition/deletion/expansion of virtual disks) are handled by the metadata master (i.e., machine 610). Each computing machine 610, 630 includes a cache 615, 635 that is controlled by a cluster cache controller 620, 640. The cluster cache controllers are devices that may be part of an interface card that interacts with a block storage device and that performs operations similar to those performed by cluster caching logics, as described above with respect to FIGS. 1 and 5, and as follows.

In a steady state read/write scenario, each virtual machine accesses its respective memory blocks in the LUN 670. Under the cluster cache coherency protocol described herein, the cluster cache controllers' permission to cache from the LUN will be dependent upon their membership in a clique as established by way of communication between the cluster cache controllers.

If virtual machine VM1 moves from computing machine 610 to computing machine 630, the cluster cache controller 620 will receive a signal that the virtualization operating system for virtual machine VM1 has initiated a VM Move operation. In response, the cluster cache controller 620 will invalidate its local cache 615 for the LUN 670. The metadata master (computing machine 610) will issue a PERSISTENT RESERVATION to reserve the LUN 670 so that the metadata can be updated. While the PERSISTENT RESERVATION is in effect, the cluster cache controller will record the memory block identifiers written to the LUN 670. The blocks being written should mostly be metadata, causing the computing machine 630 to re-read the uploaded metadata from the LUN when it needs it. Upon getting an SCSI message to revoke the reservation, the cluster cache controller 620 will first send out a message to the cluster cache controller 640 (the only other member of the clique) to invalidate the blocks written during the reservation. This ensures that the cache 635 will not contain stale metadata. After this process is complete, the cluster cache controller 620 will allow the revocation of the reservation.

If the computing machine 610 creates a new virtual machine, it will issue a PERSISTENT RESERVATION request to reserve the LUN 670, update the metadata to create a new virtual disk file and assign it block ranges from the unallocated blocks. While the PERSISTENT RESERVATION is in effect, the cluster cache controller 620 will record the memory block identifiers written to the LUN 670. The blocks being written should mostly be metadata, causing the computing machine 630 to re-read the uploaded metadata from the LUN when it needs it. Upon getting an SCSI message to revoke the reservation, the cluster cache controller 620 will first send out a message to the cluster cache controller 640 (the only other member of the clique) to invalidate the blocks written during the reservation. This ensures that the cache 635 will not contain stale metadata. After this process is complete, the cluster cache controller 620 will allow the revocation of the reservation.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Logic”, as used herein, includes but is not limited to hardware, firmware, instructions stored on a non-transitory medium or in execution on a machine, and/or combinations of each to perform a function(s) or an action(s), and/or to cause a function or action from another logic, method, and/or system. Logic may include a software controlled microprocessor, a discrete logic (e.g., ASIC), an analog circuit, a digital circuit, a programmed logic device, a memory device containing instructions, and so on. Logic may include one or more gates, combinations of gates, or other circuit components. Where multiple logics are described, it may be possible to incorporate the multiple logics into one physical logic. Similarly, where a single logic is described, it may be possible to distribute that single logic between multiple physical logics. One or more of the components and functions described herein may be implemented using one or more of the logic elements.

While for purposes of simplicity of explanation, illustrated methodologies are shown and described as a series of blocks. The methodologies are not limited by the order of the blocks as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional, not illustrated blocks.

To the extent that the term “includes” or “including” is employed in the detailed description or the claims, it is intended to be inclusive in a manner similar to the term “comprising” as that term is interpreted when employed as a transitional word in a claim.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the disclosure is not limited to the specific details, the representative apparatus, and illustrative examples shown and described. Thus, this application is intended to embrace alterations, modifications, and variations that fall within the scope of the appended claims.

What is claimed is:

1. An apparatus, comprising:
non-transitory storage media configured as a cache associated with a computing machine; wherein the computing machine is a member of a cluster of computing machines that share access to a storage device; and
a cluster caching logic associated with the computing machine, wherein the caching logic is configured to:
communicate with cluster caching logics associated with the other computing machines to determine an operational status of a clique of cluster caching logics performing caching operations on data in the storage device; and
selectively enable caching of data from the storage device in the cache based, at least in part, on a membership status of the cluster caching logic in the clique.

2. The apparatus of claim 1, wherein the cluster caching logic is configured to enable caching of data from the storage device when the cluster caching logic is a member of the clique and to disable caching when the cluster caching logic is not a member of the clique.

3. The apparatus of claim 1, wherein the cluster caching logic is configured to disable caching of data from the storage device when a health status of the clique is degraded.

4. The apparatus of claim 3, wherein the cluster caching logic is configured to determine the health status of the clique by broadcasting a health check message to other clique members and subsequently broadcasting a clique degradation message indicating that the health status of the clique is degraded if a response is not received from the other members of the clique.

5. The apparatus of claim 1, wherein the cluster caching logic is configured to disable caching in response to receiving a clique degradation message.

6. The apparatus of claim 1, wherein the cluster caching logic is configured to invalidate data in the cache of the computing machine when the computing machine ceases hosting of a virtual machine having a virtual disk file cached in the cache.

7. The apparatus of claim 1, wherein the cluster caching logic is configured to:
detect a persistent reserve message from a requesting cluster caching logic in the clique reserving exclusive access to the memory device;
record a list of memory blocks written by the requesting cluster caching logic while the storage device is reserved;
detect a revocation message from the requesting cluster caching logic;
broadcast the list of memory blocks to the cluster caching logics in the clique; and
broadcast a clique degradation message indicating that a health status of the clique is degraded if a response is not received from all members of the clique.

8. A method, comprising:
determining membership in a clique of caching logics that cache data from a shared storage device; and
if membership in the clique is established, enabling caching of data from the shared storage device in a cache.

9. The method of claim 8, further comprising:
broadcasting a health check message to other clique members;
monitoring for a response from the other clique members; and
if a response is not received from the other clique members, broadcasting a clique degradation message indicating that a health status of the clique is degraded.

10. The method of claim 9, further comprising:
receiving a token from another cluster caching logic that is a member of the clique;
broadcasting the health check message in response to receiving the token; and
passing the token to another member of the clique after receiving a response from all the clique members or broadcasting the clique degradation message.

11. The method of claim 8, further comprising invalidating data in the cache corresponding to a virtual disk of a virtual machine if the virtual machine is deleted.

12. The method of claim 8, further comprising invalidating data in the cache corresponding to a virtual disk of a virtual machine if the virtual machine moves to a different host computing machine.

13. The method of claim 8, further comprising disabling caching in response to receiving a clique degradation message received from a member of the clique.

14. The method of claim 13, further comprising resuming caching in response to a resume caching message received from a member of the clique.

15. The method of claim 8, further comprising:
detecting a persistent reserve message from a requesting cluster caching logic in the clique reserving exclusive access to the shared memory device;
recording a list of memory blocks written by the requesting cluster caching logic while the shared storage device is reserved;
detecting a revocation message from the requesting cluster caching logic;
broadcasting the list of memory blocks to the cluster caching logics in the clique; and
broadcasting a clique degradation message indicating that a health status of the clique is degraded if a response is not received from all members of the clique.

16. A cluster cache controller configured for coupling to a physical computing machine, wherein the cluster cache controller is configured to:
assess a health status of a clique of cluster cache controllers that cache data from a shared storage device;
determine the cluster cache controller's membership status with respect to the clique; and
if the cluster cache controller is a member of the clique and the health status of the clique is not degraded, enabling caching in a cache associated with the physical computing machine.

17. The cluster cache controller of claim 16, wherein the cluster cache controller is further configured to, prior to performing caching operations, perform the following:
establish an out-of-band connection with at least one cluster cache controller that is a member of the clique; and
register as a member of the clique.

18. The device of claim 16 wherein the cluster cache controller is further configured to:
broadcast a health check message to other clique members;
monitor for a response from the other clique members; and
if a response is not received from each of the other clique members, broadcast a clique degradation message indicating that the health status of the clique is degraded.

19. The device of claim 16 wherein the cluster cache controller is further configured to invalidate data in the cache when the physical computing machine ceases hosting of a virtual machine having a virtual disk file cached in the cache.

20. The cluster cache controller of claim 16 wherein the cluster cache controller is further configured to disable caching and invalidate data in the cache in response to receiving a clique degradation message.

21. The cluster cache controller of claim 16 wherein the cluster cache controller is further configured to:
detect a persistent reserve message from a requesting cluster caching logic in the clique reserving exclusive access to the shared memory device;
record a list of memory blocks written by the requesting cluster caching logic while the shared storage device is reserved;
detect a revocation message from the requesting cluster caching logic;
broadcast the list of memory blocks to the cluster caching logics in the clique; and
broadcast a clique degradation message indicating that the health status of the clique is degraded if a response is not received from all members of the clique.
